(19) United States
(12) Patent Application Publication
(10) Pub. No.: US 2023/0064232 A1
(43) Pub. Date: Mar. 2, 2023

(54) UNIVERSAL CALIBRATION TARGETS AND CALIBRATION SPACES

(71) Applicant: Motional AD LLC, Boston, MA (US)

(72) Inventors: Jun Shern Chan, SINGAPORE (SG); Francisco Alejandro Suarez Ruiz, Singapore (SG); Jeremy Myers, Dormont, PA (US); Maurilio Di Cicco, Boston, MA (US); Lucas Tetsuya Kuwae, Singapore (SG); Alejandro Israel Barragan Diaz, Singapore (SG)

(21) Appl. No.: 17/459,154

(22) Filed: Aug. 27, 2021

(51) Int. Cl. G01S 7/40; G01S 13/86; G01S 7/02

(52) U.S. Cl. CPC G01S 7/4004; G01S 13/867; G01S 13/865; G01S 7/027; G01S 7/4086

(57) ABSTRACT

Among other things, techniques are described for a universal calibration target. The universal calibration target includes a core and an outer body. The core is core associated with a first salient property. The outer body is associated with a second salient property. The first salient property and the second salient property are configured to be observed by a sensor modality, and the first salient property and the second salient property correspond to at least one sensor of a vehicle.

### FIELD OF THE INVENTION

This description relates generally to universal calibration targets and calibration spaces.

### BACKGROUND

Autonomous vehicles use sensor data to navigate and understand the surrounding environment. Sensors are calibrated to compensate for inaccuracies in sensor measurements. The calibration of each sensor may use a different calibration target. As a result, the number of targets used for calibration is directly proportional to the number of sensors to be calibrated. Moreover, conditions of the space in which calibration occurs may impede the calibration process.

### BRIEF DESCRIPTION OF THE DRAWINGS

FIG. 1 shows an example of an autonomous vehicle having autonomous capability.

FIG. 2 shows an example “cloud” computing environment.

FIG. 3 shows a computer system.

FIG. 4 shows an example architecture for an autonomous vehicle.

FIG. 5 shows an example of inputs and outputs that can be used by a perception module.

FIG. 6 shows an example of a LiDAR system.

FIG. 7 shows the LiDAR system in operation.

FIG. 8 shows the operation of the LiDAR system in additional detail.

FIG. 9A is an illustration of universal calibration target core.

FIG. 9B is an illustration of a universal calibration target core and outer body.

FIG. 10 is an illustration of a universal calibration target.

FIG. 11 is an illustration of a universal calibration target with paint or material applied to a surface of the outer body.

FIG. 12 is a cross-section of a universal calibration target with a pattern or color applied to a surface of the outer body.

FIG. 13 is an illustration of a universal calibration target.

FIG. 14 is an illustration of a calibration space.

FIG. 15 is an illustration of a calibration space with a plurality of universal calibration targets along a path.

FIG. 16 is an illustration of calibration procedure lifecycle.

FIG. 17 is an illustration of a plurality of calibration targets in calibration room.

FIG. 18 is a process flow diagram of a process for universal calibration using universal calibration targets.

### DETAILED DESCRIPTION

In the following description, for the purposes of explanation, numerous specific details are set forth in order to provide a thorough understanding of the present invention. It will be apparent, however, that the present invention can be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. AV Architecture

4. AV Inputs

5. Universal Calibration Targets

6. Calibrations Spaces/Rooms

7. Universal Calibration Processes

### General Overview

A calibration target is generally selected based on, at least in part, salient properties of the calibration target that can be detected by a corresponding sensor according to the sensor modality. A robotic platform (such as an autonomous vehicle) can have multiple sensors that are used to realize robotic functionality. Each sensor is associated with at least one sensor modality and observes a salient property of a calibration target, wherein target data associated with the observation is captured or quantified by the sensor. Thus, salient properties of a calibration target is selected or designed based on a likelihood of the salient property leveraging one or more sensor modalities. During calibration, each sensor observes one or more targets and captured data from the observation is recorded to determine intrinsic and extrinsic calibration parameters associated with the sensor. The calibration of a sensor enables accurate and precise operation of the sensor. A universal calibration target fuses a plurality of distinct salient properties that each correspond to one or more sensor modalities into a single universal calibration target. During verification, a sensor observes one or more targets to capture data that is compared with expected data values to verify proper operation of a sensor. In some instances, calibration occurs in a calibration room designed for full sensor calibration and validation to suit the calibration needs of operating a large fleet of mobile robots.

Some advantages of a universal calibration target include a time efficient procedure that can use a single round of calibration to calibrate all sensors. The universal calibration target is cost effective and easy to manufacture in bulk. Further, the universal calibration target is easy to deploy and enables replicable and robust calibration procedures. Moreover, due to the diversity of natural environments and their conditions which may or may not contain robust properties, it is advantageous to perform calibration in a calibration room with known targets to ensure the reliability and repeatability of the procedures.

### System Overview

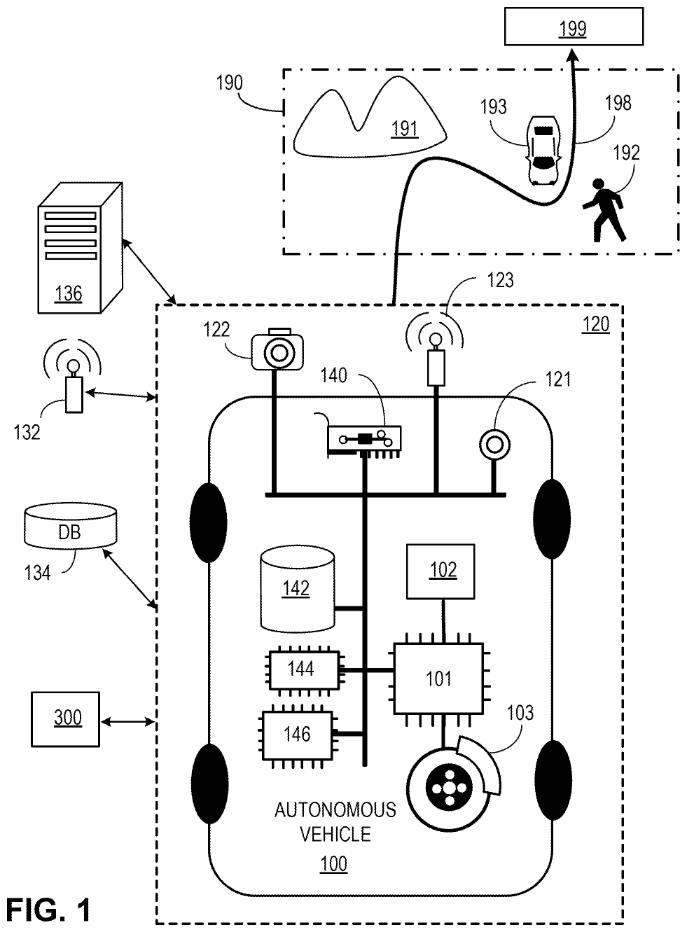

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

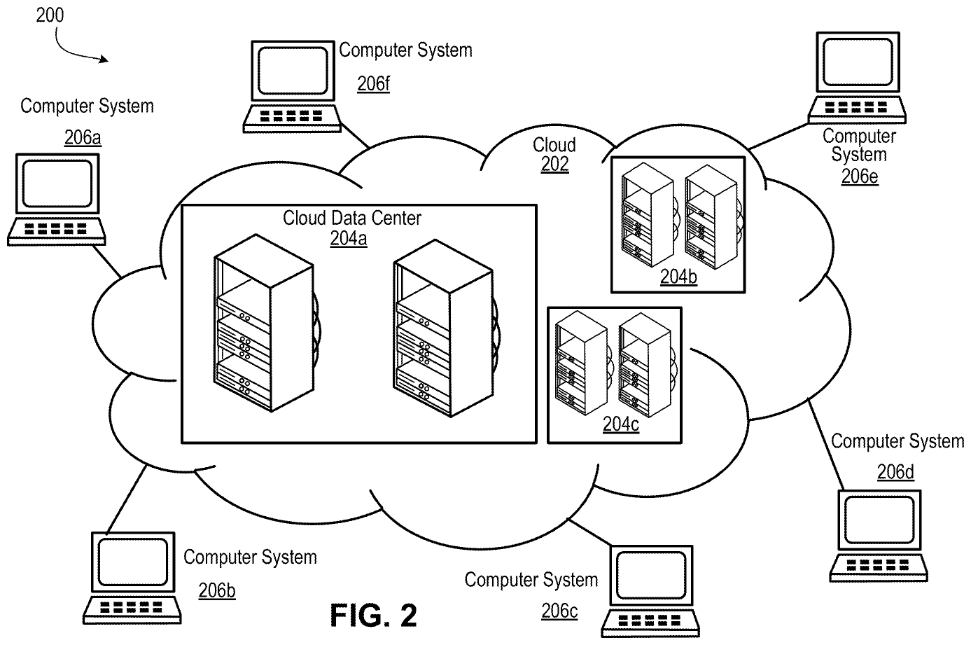

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 200 described below with respect to FIG. 2.

In general, this document describes technologies applicable to any vehicles that have one or more autonomous capabilities including fully AVs, highly AVs, and conditionally AVs, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially AVs and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems can automate certain vehicle operations (e.g., steering, braking, and using maps) under certain operating conditions based on processing of sensor inputs. The technologies described in this document can benefit vehicles in any levels, ranging from fully AVs to human-operated vehicles.

AVs have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the vehicle 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, including instructions for a vehicle to start moving forward, stop moving forward, start moving backward, stop moving backward, accelerate, decelerate, perform a left turn, and perform a right turn. In an embodiment, computing processors 146 are similar to the processor 204 described below in reference to FIG. 2. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the vehicle 100, such as the AV's position, linear and angular velocity and acceleration, and heading (e.g., an orientation of the leading end of vehicle 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 208 or storage device 210 described below in relation to FIG. 2. In an embodiment, memory 144 is similar to the main memory 206 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the vehicle 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the vehicle 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment. The communication devices 140 transmit data collected from sensors 121 or other data related to the operation of vehicle 100 to the remotely located database 134. In an embodiment, communication devices 140 transmit information that relates to teleoperations to the vehicle 100. In some embodiments, the vehicle 100 communicates with other remote (e.g., “cloud”) servers 136.

In an embodiment, the remotely located database 134 also stores and transmits digital data (e.g., storing data such as road and street locations). Such data is stored on the memory 144 on the vehicle 100, or transmitted to the vehicle 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data can be stored on the memory 144 on the vehicle 100, or transmitted to the vehicle 100 via a communications channel from the remotely located database 134.

Computer processors 146 located on the vehicle 100 algorithmically generate control actions based on both real-time sensor data and prior information, allowing the AV system 120 to execute its autonomous driving capabilities.

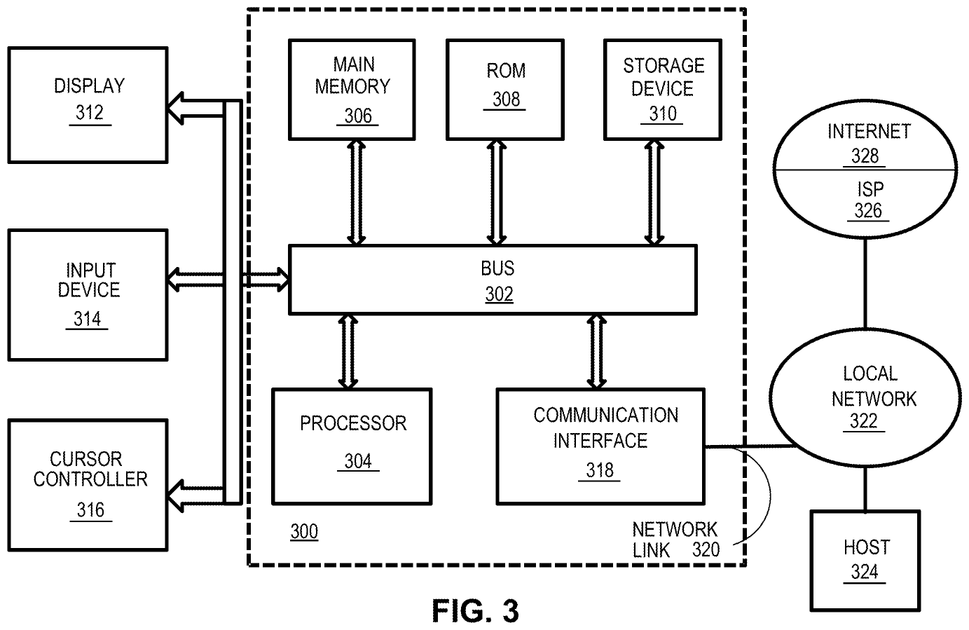

In an embodiment, the AV system 120 includes computer peripherals 132 coupled to computer processors 146 for providing information and alerts to, and receiving input from, a user (e.g., an occupant or a remote user) of the vehicle 100. In an embodiment, peripherals 132 are similar to the display 312, input device 314, and cursor controller 316 discussed below in reference to FIG. 3. The coupling is wireless or wired. Any two or more of the interface devices can be integrated into a single device.

In an embodiment, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In an embodiment, the privacy level specifies particular information associated with a passenger that is deleted once the ride is completed. In an embodiment, the privacy level specifies particular information associated with a passenger and identifies one or more entities that are authorized to access the information. Examples of specified entities that are authorized to access information can include other AVs, third party AV systems, or any entity that could potentially access the information.

A privacy level of a passenger can be specified at one or more levels of granularity. In an embodiment, a privacy level identifies specific information to be stored or shared. In an embodiment, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In an embodiment, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 shows an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, AVs (including, cars, drones, shuttles, trains, buses, etc.) and consumer electronics. In an embodiment, the computing systems 206a-f are implemented in or as a part of other systems.

FIG. 3 shows a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or can include one or more general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a processor 304 coupled with a bus 302 for processing information. The processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and uses an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 can optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### AV Architecture

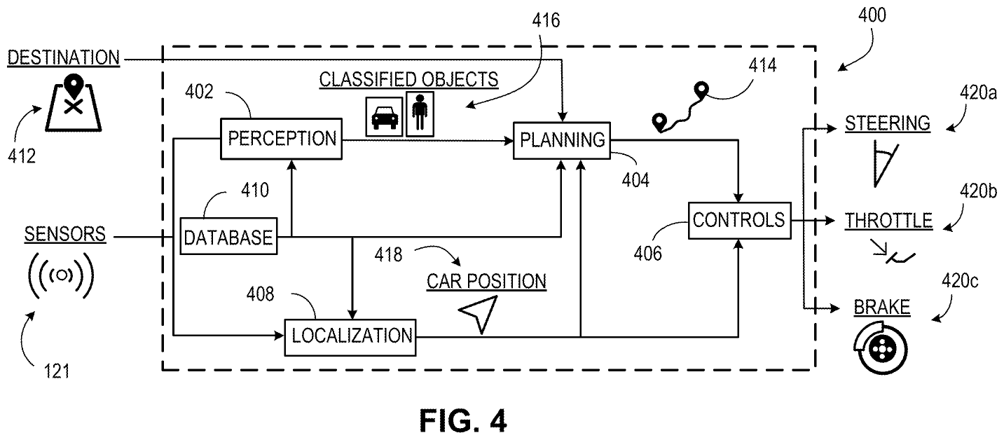

FIG. 4 shows an example architecture 400 for an AV (e.g., the vehicle 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the vehicle 100. Together, the modules 402, 404, 406, 408, and 410 can be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the modules 402, 404, 406, 408, and 410 is sometimes referred to as a processing circuit (e.g., computer hardware, computer software, or a combination of the two). A combination of any or all of the modules 402, 404, 406, 408, and 410 is also an example of a processing circuit.

In use, the planning module 404 receives data representing a destination 412 and determines data representing a trajectory 414 (sometimes referred to as a route) that can be traveled by the vehicle 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Navigation Satellite System) sensor and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control module 406 receives the data representing the trajectory 414 and the data representing the AV position 418 and operates the control functions 420a-c (e.g., steering, throttling, braking, ignition) of the AV in a manner that will cause the vehicle 100 to travel the trajectory 414 to the destination 412. For example, if the trajectory 414 includes a left turn, the control module 406 will operate the control functions 420a-c in a manner such that the steering angle of the steering function will cause the vehicle 100 to turn left and the throttling and braking will cause the vehicle 100 to pause and wait for passing pedestrians or vehicles before the turn is made.

### AV Inputs

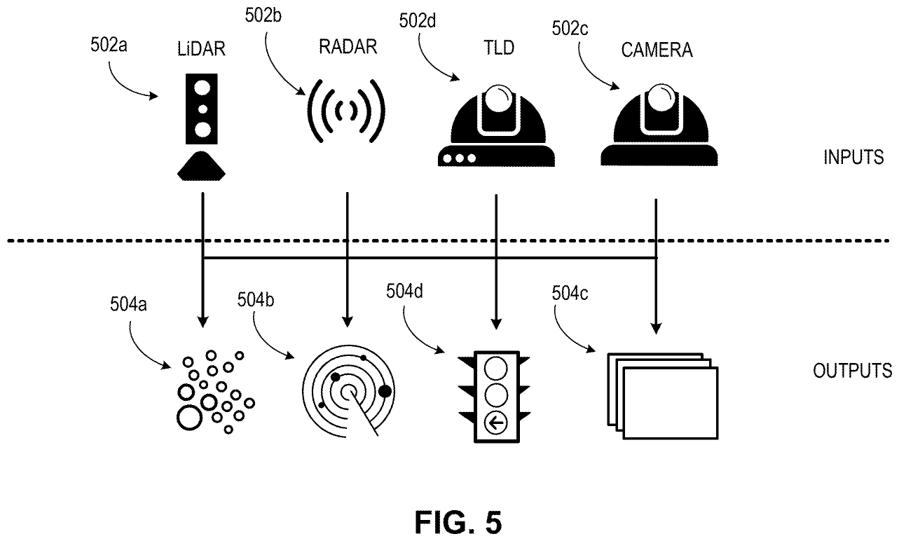

FIG. 5 shows an example of inputs 502a-d (e.g., sensors 121 shown in FIG. 1) and outputs 504a-d (e.g., sensor data) that is used by the perception module 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In some embodiments, the camera system is configured to “see” objects far, e.g., up to a kilometer or more ahead of the AV. Accordingly, in some embodiments, the camera system has features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the vehicle 100 has access to all relevant navigation information provided by these objects. For example, the viewing angle of the TLD system is about 120 degrees or more.

In some embodiments, outputs 504a-d are combined using a sensor fusion technique. Thus, either the individual outputs 504a-d are provided to other systems of the vehicle 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

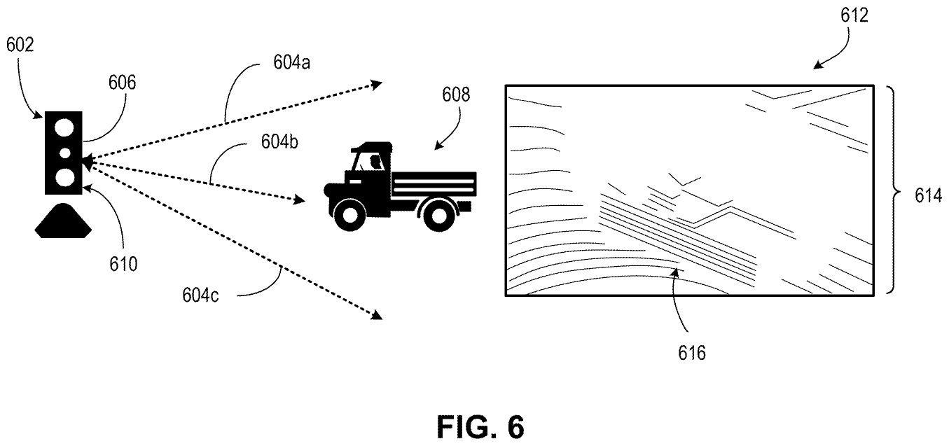

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

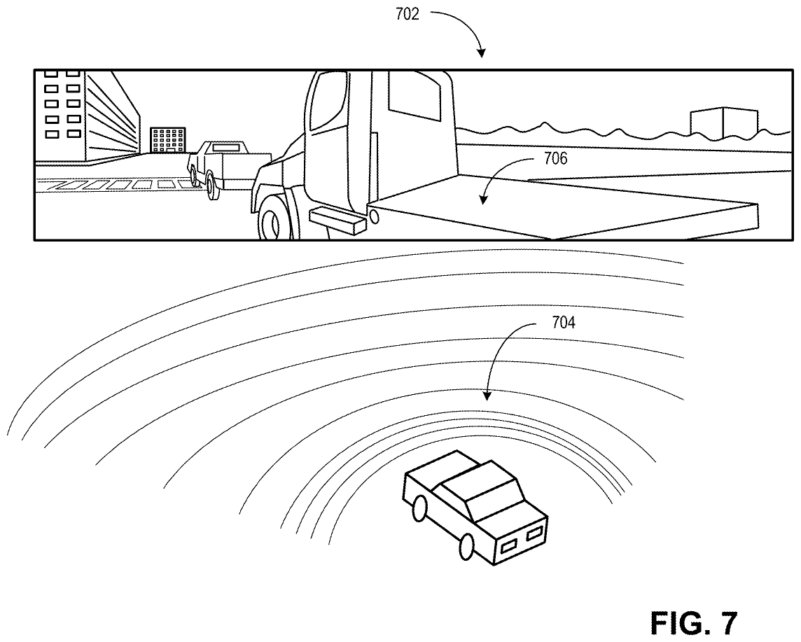

FIG. 7 shows the LiDAR system 602 in operation. In the scenario shown in this figure, the vehicle 100 receives both camera system output 504c in the form of an image 702 and LiDAR system output 504a in the form of LiDAR data points 704. In use, the data processing systems of the vehicle 100 compares the image 702 to the data points 704. In particular, a physical object 706 identified in the image 702 is also identified among the data points 704. In this way, the vehicle 100 perceives the boundaries of the physical object based on the contour and density of the data points 704.

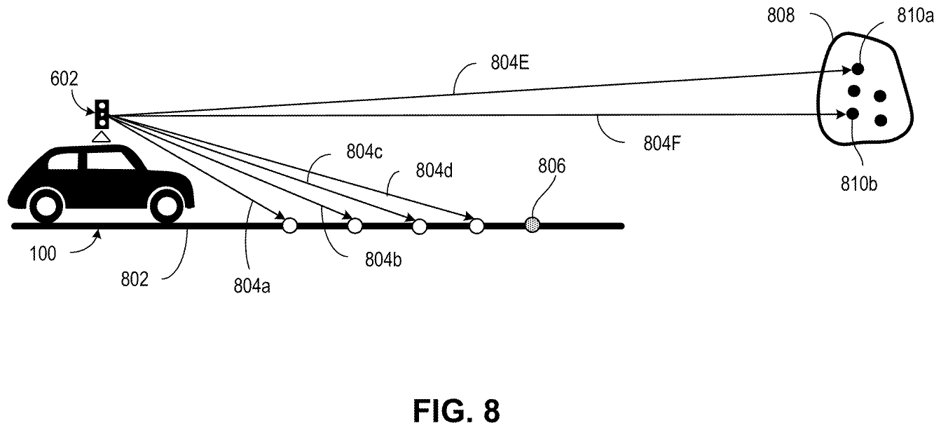

FIG. 8 shows the operation of the LiDAR system 602 in additional detail. As described above, the vehicle 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the vehicle 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the vehicle 100 can determine that the object 808 is present.

### Universal Calibration Targets

Generally, a calibration target enables the calculation or verification of parameters associated with a sensor (e.g., sensors 121 of FIG. 1). The parameters define a relationship between the sensor and the environment (e.g., environment 190 of FIG. 1) or the internal hardware of the sensor itself. Extrinsic parameters relate to external characteristics of the sensor, such as those that relate data captured by the sensor to the surrounding environment. Intrinsic parameters are those parameters that relate to the internal characteristics of the sensor itself. Sensors are operable to observe the surrounding environment and capture data according to the respective modality of the sensor. Generally, a modality of a sensor refers to the type of raw data, a quality, or a state that can be observed by the sensor. For example, a camera or imaging sensor (e.g., cameras 122 of FIG. 1) observes pixels, such as Red, Green, Blue (RGB) data. A LiDAR (e.g., LiDAR 123 of FIG. 1) observes electromagnetic radiation, for example light in the visible spectrum including laser beams reflected back from objects in the environment. A radar observes radio waves. Each type of sensor can be calibrated to ensure accurate and precise operation of the sensor.

Calibration and verification are typically performed by observing a target via the sensor. The target is associated with known properties. For example, the calibration of an imaging sensor is performed by capturing image data and deriving calibration parameters associated with the imaging sensor based on the actual captured imaging data and the ground truth imaging data. Ranging devices, such as a LiDAR, radar, ultrasonic sensor, Time Of Flight (TOF) depth sensors, and the like can be calibrated by emitting a signal and measuring a return signal, sometimes referred to as an echo. Calibration parameters for a ranging device can be derived based on the measured return signal and the ground truth return signal. Similarly, LiDAR devices can be calibrated by emitting laser beams and measuring the reflections. Calibration parameters for a LiDAR are derived based on the measured reflections and the ground truth reflections. Generally, calibration compensates for inaccuracies by applying some sort of correction derived from the actual measured data and the ground truth data.

Calibration can also be used for the verification of proper operation of sensors. As used herein, verification refers to a determination that a measurement error is smaller than a maximum permissible error. For example, a target is observed by a sensor and data captured by the sensor is analyzed to determine if the captured data is adequate for the intended use. In examples, the captured data is adequate for an intended use when errors in the data are below the maximum permissible error. Periodic verification can ensure the accuracy of a sensor's measurement, as sensors often experience errors that accumulate over time. Cumulative errors cause a drift in sensor measurement, which can be discovered during a verification process. Errors such as hysteresis errors, noise, sensitivity errors, and biasing of the sensors can also be discovered via verification.

Accordingly, each sensor is calibrated or its operation verified by observing a target with properties that designed to be observed by a sensor's respective modality and capturing the associated data. These properties are known or predetermined by designing the calibration target in view of the properties. In an embodiment, for calibration or verification the target is positioned at a particular location with respect to the sensor to fix the distance at a known value. A universal calibration target fuses a plurality of distinct salient properties that each correspond to one or more sensor modalities into a single calibration target. As used herein, a property of the target is salient when the property can be perceived or observed by a corresponding sensor. A salient property is intentionally implemented at the universal calibration target for the purpose of being observed by a corresponding sensor. In an embodiment, a salient property of the universal calibration target is selected based on a configuration of the corresponding sensor. For example, calibration of a sparse LiDAR device corresponds to properties that are different than those used to calibrate a dense or other type of LiDAR. In an embodiment, a salient property corresponds to a plurality of sensors. For example, the same salient property of the universal calibration target is used to calibrate more than one sensor. In an embodiment, a calibration space is configured for calibration or verification of one or more sensors. Properties of the calibration space corresponding to the modality of one or more sensors are predetermined or controlled to ensure efficient calibration or verification of the one or more sensors.

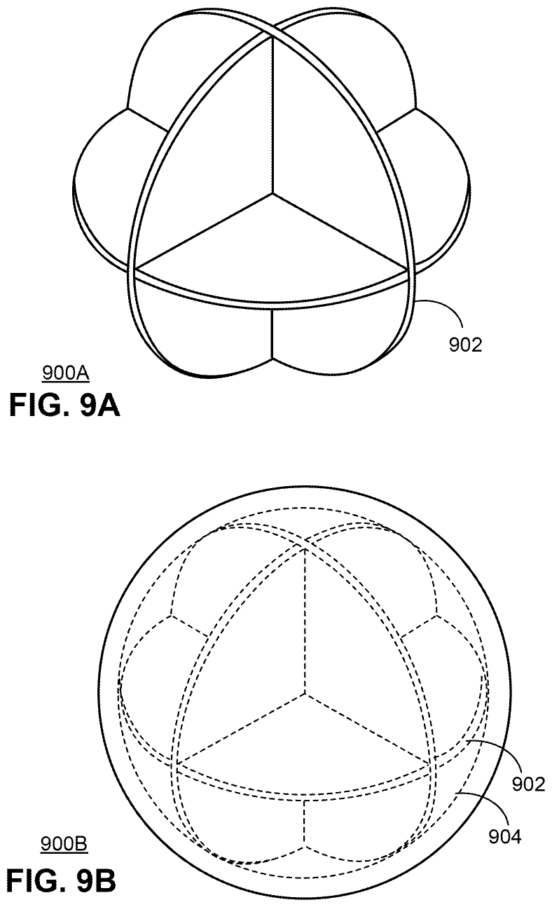

FIG. 9A is an illustration of a portion of a universal calibration target. The portion 900A of the universal calibration target is a core 902. Properties of the core 902 are designed for observation by one or more corresponding sensory modalities. The core 902 is configured such that when a corresponding sensor observes the core at varying lines of sight, at various distances, or any combination thereof, the ground truth values are known. A ground truth value is a data value or a range of values that should be captured by the sensor when observing a target with a known property, at varying lines of sight, at various distances, or any combinations thereof. Generally, the actual data captured by the sensor observation is compared with the corresponding ground truth value. Calibration parameters are derived based on the actual data captured by the sensor in view of the expected ground truth value.

For example, the calibration of an image sensor is performed by observing a pattern with a highly structured geometry, such as a chessboard. Dimensions of the chessboard are known and can be directly measured using any tool that measures distances, such as a rule or line gauge. When the chessboard is placed in a position for calibration, coordinates of various points on the chessboard are known as well. In an embodiment, a ground truth value for an image sensor is the known dimensions of a pattern, known coordinates associated with the pattern, or any combinations thereof. In another example, the calibration of reflectivity measurements of a LiDAR is performed by observing reflections of light emitted from the LiDAR. The reflectivity of a target can be directly measured using any tool that measures reflections, such as a spectrometer. In an embodiment, a ground truth value for a LiDAR is the known reflectivity of a target. In another example, a LiDAR and image sensor may be calibrated to determine a rigid transformation matrix that maps correspondences between a point cloud (e.g., output 504a of FIG. 5) output by the LiDAR and image data (e.g., output 504c of FIG. 5) output by an image sensor. Again, dimensions and coordinates of the chessboard are known. In an embodiment, a ground truth value for LiDAR and image sensor calibration is the known dimensions of a pattern, known coordinates associated with the pattern, or any combinations thereof. Data points along the target are captured by each of the LiDAR and image sensor observing the same salient property, and used to establish point correspondences between the sensors.

The core 902 is designed to calibrate a radar. Generally, radio waves reflected by the core 902 return to the radar and provide information, including but not limited to, information regarding the location, speed, and other characteristics of the core 902. In embodiments, the core is a reflector or a radar reflector. The core 902 is configured to be observed by the radar by reflecting radio waves output by the radar in a predetermined manner. The reflected radio waves are observed by a receiver associated with the radar, and the reflected radio waves are measured to determine various properties associated with the core 902. Thus, the core 902 is associated with a first salient property that reflects radio waves in a predetermined form. A salient property refers to qualities or characteristics designed to be observed by a sensor. For example, in the case of a radar, the core is positioned or have reflector core characteristics that are designed to reflect or echo a signal with properties such as a known azimuth angle, range, radar cross section (RCS), and range-rate. Physical aspects of the core 902 are selected to strategically configure properties of the core to generate a ground truth value when observed by a radar. Calibration parameters are derived based on the differences between the actual reflected signals observed by the radar and the ground truth value.

FIG. 9B is an illustration of a universal calibration target 900B. The universal calibration target 900B includes an outer body 904 and a core 902. The core 902 is the same core 902 illustrated in FIG. 9A. For ease of illustration, the outer body 904 is illustrated as a sphere surrounding the core 902. However, the outer body 904 can surround the core 902 such that portions of the core 902 are visible from the exterior of the universal calibration target 900B. Thus, the outer body 904 is generally spherical with openings that form a cage surrounding the core 902. Additionally, portions of the outer body 904 are solid while other portions of the outer body 904 are cage-like with respect to the core 902. In embodiments, the outer body 904 rotates relative to the core 902.

Properties of the outer body 904 are designed to be observed by one or more corresponding sensory modalities. The outer body 904 is configured such that when a corresponding sensor observes the outer body 904 at varying lines of sight, at various distances, or any combination thereof, the ground truth values are known. The actual data captured by the sensor is compared with the corresponding ground truth values. In particular, calibration parameters are derived based on the actual data captured by the sensor in view of the expected ground truth values.

For example, the outer body 904 is designed to be observed by a LiDAR. Generally, a LiDAR emits infrared light using one or more lasers. In embodiments, a LiDAR uses ultraviolet, visible, or infrared light to emit light waves reflected by the target 900B. The light waves emitted by the LiDAR are reflected by the outer body 904 and received by a receiver associated with the LiDAR. The outer body 904 has characteristics that are designed to reflect light waves and the measured light waves are used to determine properties such as known range offsets, vertical offsets, relative rotations, elevation angles, azimuth angles, and scale factors. Differences in reflection times of the light waves and wavelengths are used to measure three-dimensional properties of the universal calibration target. Physical aspects of the outer body 904 are selected to strategically configure properties of the outer body to generate ground truth values when observed by a LiDAR. Calibration parameters are derived based on the differences between the actual reflected signals observed by the LiDAR and the ground truth values.

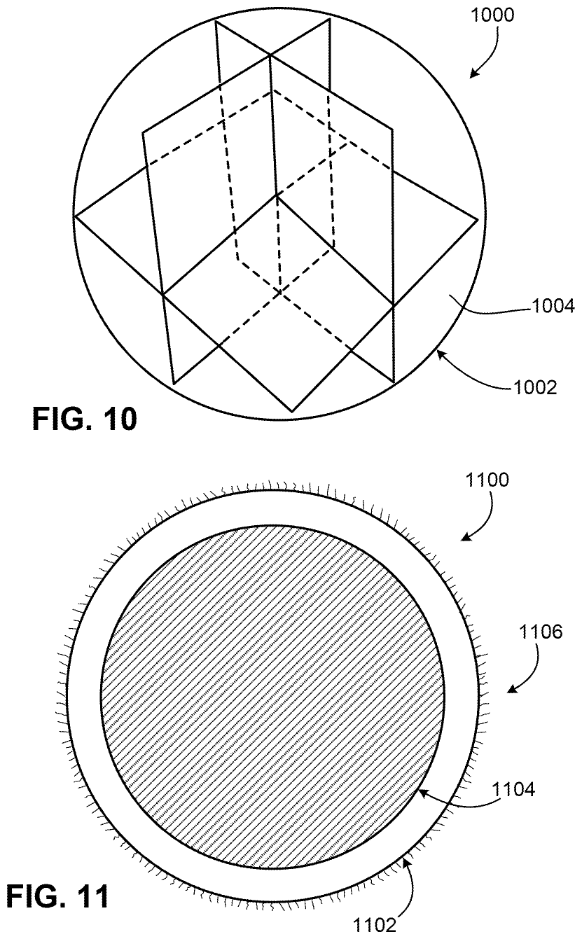

FIG. 10 is an illustration of a universal calibration target 1000. The universal calibration target 1000 includes an outer body 1002 and a core 1004. Similar to FIGS. 9A and 9B, the outer body 1002 is configured to reflect light emitted by a LiDAR, and the actual reflected signals as observed by the LiDAR are compared with ground truth values to derive calibration parameters. The outer body 1002 is configured such that portions of the core 1004 are visible (or able to reflect signals) to enable calibration of a radar. As illustrated, the core 1004 is formed from a plurality of square or rectangular planes. The square or rectangular planes reflect radio waves emitted by a radar in a predetermined manner. Accordingly, the core 1004 is associated with salient properties that are configured to be observed by a radar. Physical aspects of the core 1004 are selected to strategically configure properties of the core to generate ground truth values when observed by a radar. Calibration parameters are derived based on the differences between the actual reflected signals observed by the radar and the ground truth values.

FIG. 11 is an illustration of a universal calibration target 1100. The universal calibration target 1100 includes an outer body 1102 and core 1104. Similar to FIGS. 9A, 9B, and 10, each of the outer body 1102 and core 1104 are associated with one or more salient properties known to generate ground truth values when observed by a sensor. Similar to FIG. 9B, the outer body 1102 is generally spherical with openings that form a cage surrounding the core 1104. Additionally, portions of the outer body 1102 are solid while other portions of the outer body 1102 are cage-like with respect to the core. In an embodiment, the outer body 1102 can rotate relative to the core 1104. The outer body 1102 can be formed from a variety of materials, such as Styrofoam, paper, plastic, metal, mesh, or any combinations thereof. In an embodiment, the outer body 1102 is formed from materials that are extensible. Thus, the size of the outer body can be modified as needed through the addition or removal of components of the outer body 1102 to the universal calibration target. The universal calibration target is modified based on calibration requirements of the first sensor, the second sensor, or any combination thereof. In an embodiment, the outer body can be extended or stretched to create an outer body of various sizes.

In the example of FIG. 11, a particular paint or material 1106 is applied to the surface of the outer body 1102. The paint or material 1106 is a material that increases the reflectivity of the outer body 1102 when infrared light from a LiDAR is reflected by the outer body 1102 and material 1106. The application of the material 1106 serves to further reflect infrared light to generate ground truth values for a more precise and accurate measurement of reflected light by the LiDAR. In some examples, the application of a particular paint or material 1106 intentionally creates a predetermined amount of noise, interference, or clutter to be measured by the LiDAR sensor. In this manner, noise, interference, and clutter are pre-defined during the calibration process, thus creating a more robust calibration process that calibrates or verifies sensors in view of unwanted signals.

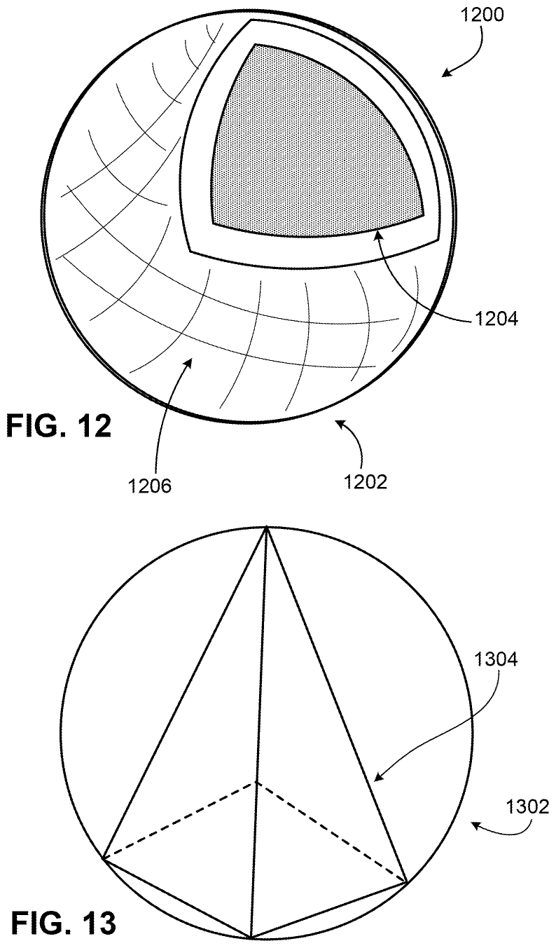

FIG. 12 is an illustration of a cross-section of universal calibration target 1200. The universal calibration target 1200 includes an outer body 1202 and a core 1204. Similar to FIGS. 9A, 9B, 10, and 11, the outer body 1202 and core 1204 are associated with one or more salient properties known to generate ground truth values when observed by a sensor. In the example of FIG. 12, the outer body 1202 has a pattern 1206 applied to the surface of the outer body 1202. The application of a particular pattern or color to the surface of the outer body 1202 is used to calibrate an imaging sensor, LiDAR, or any combination thereof.

A pattern or color applied to the surface of the outer body 1202 is a salient property of the universal calibration target 1200 configured to be observed by an imaging sensor or LiDAR. In particular, the patterns or colors applied to the outer body includes patterns with predetermined dimensions, varying colors, textures, and the like to be observed by the imaging sensor or LiDAR. The patterns or colors applied to the surface of the outer body 1202 are strategically arranged to generate ground truth values when observed by the imaging sensor or LiDAR. Calibration parameters are derived based on the differences between the actual captured imaging data, LiDAR data, and the ground truth values. Through the selection of salient properties as described above, a universal calibration target is configured to enable simultaneous data capture for calibration of a plurality of sensors, including but not limited to a monocular or stereo video camera, infrared, thermal spectra, ultrasonic sensor, time-of-flight depth sensor, radar, LiDAR, accelerometer, and the like. Additionally, a plurality of sensors are simultaneously or jointly calibrated using data captured by observing the universal calibration target. In embodiments, simultaneous calibration is calibration that occurs during a same round, pass, or observation of the target.

FIG. 13 is an illustration of a universal calibration target 1300. The universal calibration target 1300 includes an outer body 1302 and a core 1304. Similar to FIGS. 9A-12, the outer body 1302 is configured to reflect light emitted by a LiDAR, and the actual reflected signals as observed by the LiDAR are compared with the ground truth values to derive calibration parameters. The outer body 1302 is configured such that portions of the core 1304 are visible (or able to reflect signals) to enable calibration of a radar. As illustrated, the core 1304 is in the shape of a pyramid. The core 1304 reflects radio waves emitted by a radar in a predetermined manner. Accordingly, the core 1304 is associated with salient properties that are configured to be observed by a radar sensor. Physical aspects of the core 1304 are selected to strategically configure properties of the core to generate ground truth values when observed by a radar. Calibration parameters are derived based on the differences between the actual reflected signals observed by the radar and the ground truth values.

The particular core, outer body, and outer body surface configurations described herein are exemplary in nature. The described physical aspects of the core, outer body, and outer body surface can be varied to achieve at least one salient property for observation by a corresponding sensor. The universal calibration target as described herein is adaptive such that aspects of the core, outer body, and outer body surface can be designed for the calibration or verification of one or more sensors. Moreover, other aspects of calibration or verification, such as the distance and line of sight between the sensor and the universal calibration target can be used to design aspects of the core, outer body, and the surface of the outer body. For example, a universal calibration target that is designed for observation near a vehicle can be smaller than a universal calibration target designed for long range observation.

### Calibration Spaces/Rooms

As discussed above, a calibration target enables the calculation or verification of parameters associated with a sensor being calibrated. The parameters define a relationship between the sensor and the environment or the internal hardware of the sensor itself. A universal calibration target fuses properties observed for calibration or verification procedures into a single target. In some cases, sensor calibration can be made more robust by controlling the environment in which calibration is performed. A calibration space is a facility dedicated for full sensor calibration and validation of mobile robots, including autonomous vehicles, designed to suit the calibration needs of operating a large fleet of mobile robots. The calibration space is an outdoor space or an indoor space, such as a room. The calibration space include properties selected or designed based on a likelihood of the property of being observed by one or more sensor modalities. Additionally, the room includes one or more calibration targets, universal calibration targets, or any combinations thereof. In embodiments, the one or more calibration targets are positioned at various locations within the field of view of each sensor (e.g., field of view 614 of the LiDAR system of FIG. 6) for calibration. One or more vehicles are calibrated using the calibration space.

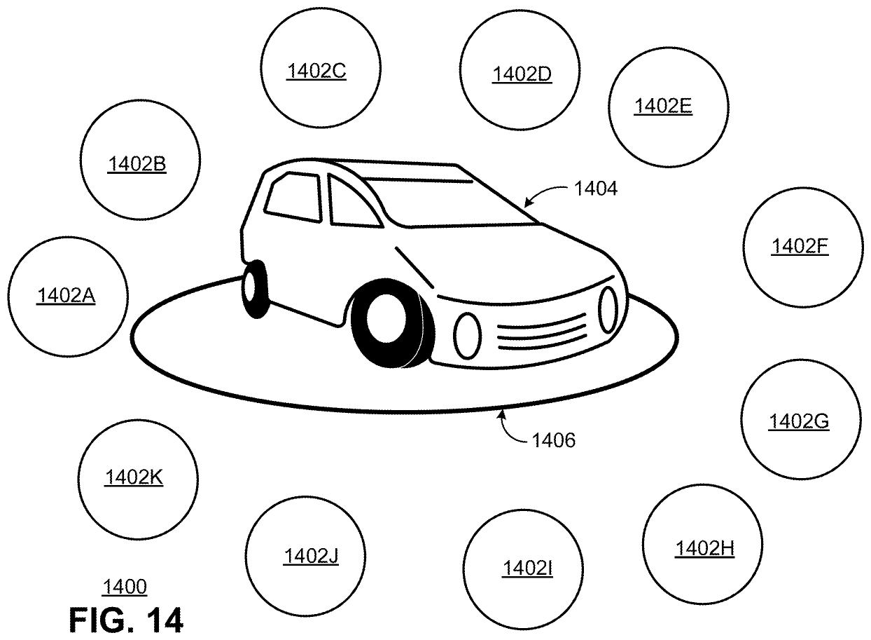

FIG. 14 is an illustration of a calibration space 1400. A vehicle 1404 (e.g., vehicle 100 of FIG. 1) is positioned on top of a turntable 1406. A plurality of calibration targets 1402A-1402K (e.g., universal calibration target 900B of FIG. 9B, universal calibration target 1000 of FIG. 10, universal calibration target 1100 of FIG. 11, universal calibration target 1200 of FIG. 12, universal calibration target 1300 of FIG. 13), are positioned at various locations throughout the calibration space. Sensor calibration in general relies on the observation of salient properties of targets or in the sensed environment (e.g., environment 190 of FIG. 1). Given the diversity of natural environments and their conditions which may or may not contain robust properties, it is advantageous to perform calibration in a controlled environment with known targets to ensure the reliability and repeatability of the procedures.

Many mobile robots have an array of sensors that jointly cover a three-hundred and sixty degree field of view (FOV) of the robot. In order to calibrate all the individual sensors, each sensor must be presented with a sufficiently informative scene. Traditionally, this is done by moving the robot around if the calibration area is sufficiently large relative to the robot, or by manually moving calibration targets around the robot. As illustrated, sensor calibration is performed by turning the vehicle 1404 atop the turntable 1406.

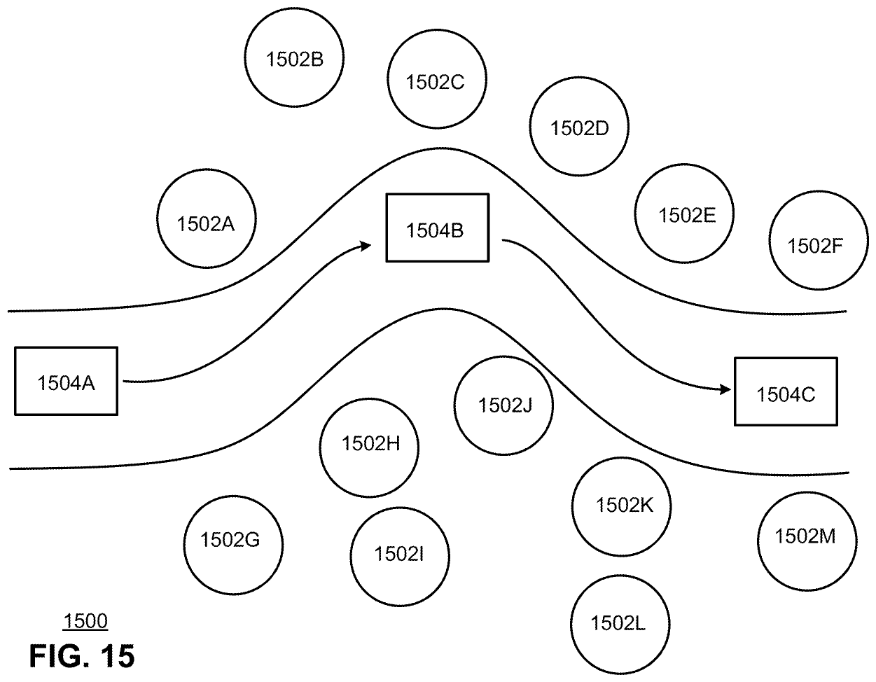

FIG. 15 is an illustration of a calibration space 1500. A plurality of vehicles 1504 are illustrated along a path 1506. Each of the vehicles 1504A, 1504B, and 1504C (e.g., vehicle 100 of FIG. 1) navigate the path 1506 from left to right. The calibration targets 1502A-1502M are positioned at various locations throughout the calibration space. Similar to the calibration space 1402 of FIG. 14, calibration is performed as each vehicle traverses the path, observing the targets 1502A-1502M. In embodiments, the targets are universal calibration targets (e.g., universal calibration target 900B of FIG. 9B, universal calibration target 1000 of FIG. 10, universal calibration target 1100 of FIG. 11, universal calibration target 1200 of FIG. 12, universal calibration target 1300 of FIG. 13). As illustrated in FIG. 15, a plurality of vehicles traverse the path 1506 and each vehicle is calibrated at the same time.

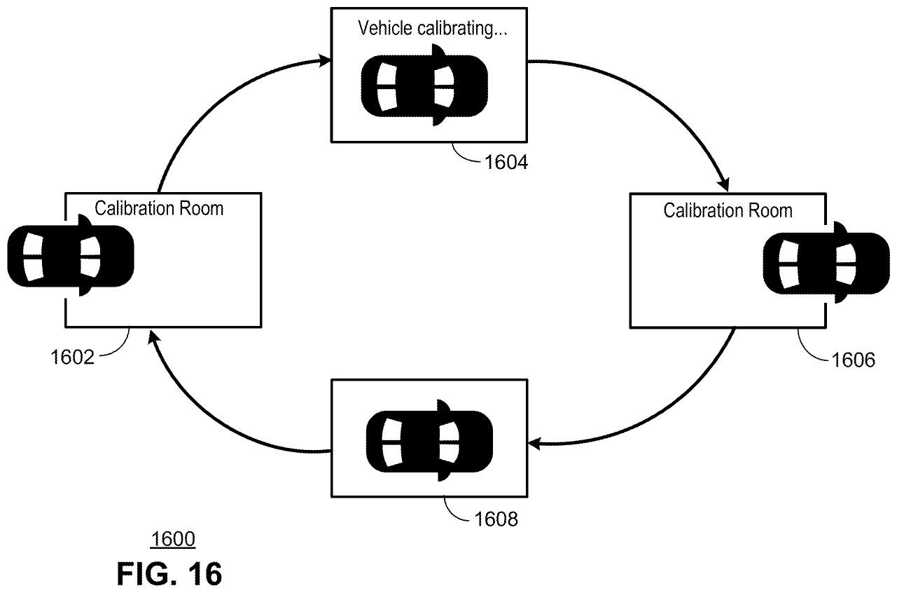

FIG. 16 is an illustration of a calibration procedure lifecycle. For ease of description, the calibration procedure is illustrated as using a calibration room. However, calibration can be performed using one or more targets in a calibration space (e.g., calibration space 1400 of FIG. 14, calibration space 1500 of FIG. 15) or a calibration area. At reference number 1602, a vehicle (e.g., vehicle 100 of FIG. 1) enters a calibration room and automated calibration begins. At reference number 1604, calibration occurs. In embodiments, calibration is performed using one or more calibration targets, universal calibration targets (e.g., universal calibration target 900B of FIG. 9B, universal calibration target 1000 of FIG. 10, universal calibration target 1100 of FIG. 11, universal calibration target 1200 of FIG. 12, universal calibration target 1300 of FIG. 13), or any combinations thereof. Additionally, calibration is performed using particular calibration room properties, natural properties, or any combinations thereof. At reference number 1606, the calibrated vehicle exits the calibration room. At reference number 1608, the calibrated vehicle is used for typical operations. In the example of a vehicle, the vehicle operates using the calibrated sensor functionality.

A vehicle with calibrated sensors operates as intended with sensors that are calibrated for accuracy and precision. However, during normal use, data captured by the once calibrated sensors drift or otherwise become corrupted. For example, sensors often experience errors that accumulate over time. The cumulative error causes a drift in sensor measurement, which can be discovered during a verification process. Other errors, such as hysteresis errors, noise, sensitivity errors, and biasing of the sensors can occur and can also be discovered via verification. Thus, the accuracy of sensor measurements can degrade over time. Accordingly, the vehicle returns to the calibration room at reference number 1602 for verification of sensor operation. In this manner, proper sensor operation can be maintained.

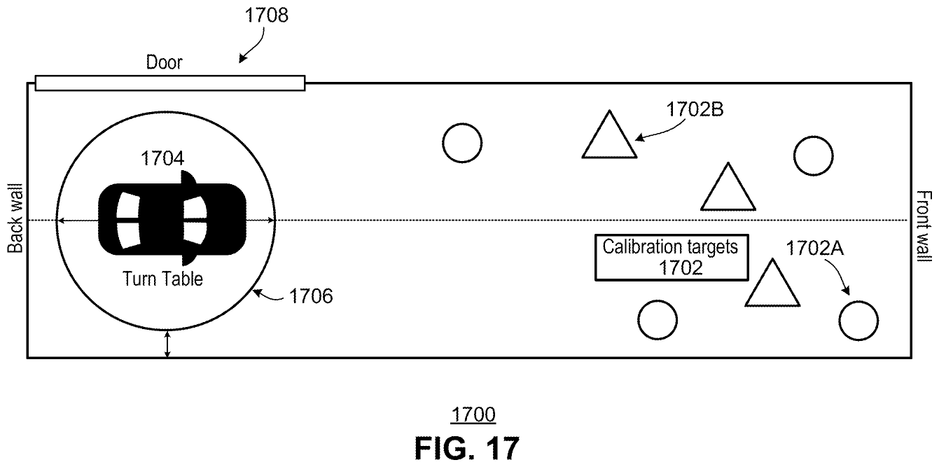

FIG. 17 is an illustration of a calibration room 1700 with a number of calibration targets 1702. A vehicle 1704 (e.g., vehicle 100 of FIG. 1) is positioned on top of a turntable 1706. To access the calibration room, the vehicle 1704 enters the calibration room through the door 1708. As illustrated, the targets are universal calibration targets 1702A (e.g., universal calibration target 900B of FIG. 9B, universal calibration target 1000 of FIG. 10, universal calibration target 1100 of FIG. 11, universal calibration target 1200 of FIG. 12, universal calibration target 1300 of FIG. 13) or calibration targets 1702B.

In the example of FIG. 17, calibration procedures make use of actuation and automated data collection so that calibration is fully unsupervised. For example, various aspects of calibration can be varied using an automated procedure. Other aspects of the calibration room 1700 are varied, such as the lighting, vehicle position via a turntable, and the particular targets used for calibration. For ease of illustration, the targets are illustrated at the same ground level of the vehicle to be calibrated. However, targets can be placed at any height within the calibration room. In an embodiment, targets are placed along the walls, ceiling, and ground of the calibration room. Further, the calibration targets can be of any type, such as universal calibration targets as described above, other calibration targets, including but not limited to boards, diamonds, etc., or any combinations thereof

The use of a calibration space enables repeatability and reliability of calibration results and can also increase safety during calibration. The calibration space also enables time efficiencies, such as fast calibration of a fleet, thereby reducing vehicle maintenance and downtime. By automating the calibration procedure, the ease-of-use increases, as there is no need for expert users to implement the calibration procedure. Thus, limited training is required for operators of the calibration space. In an example, the calibration space is integrated into a production line, and can support various kinds of vehicles, motorbikes, boats.

### Calibration Processes

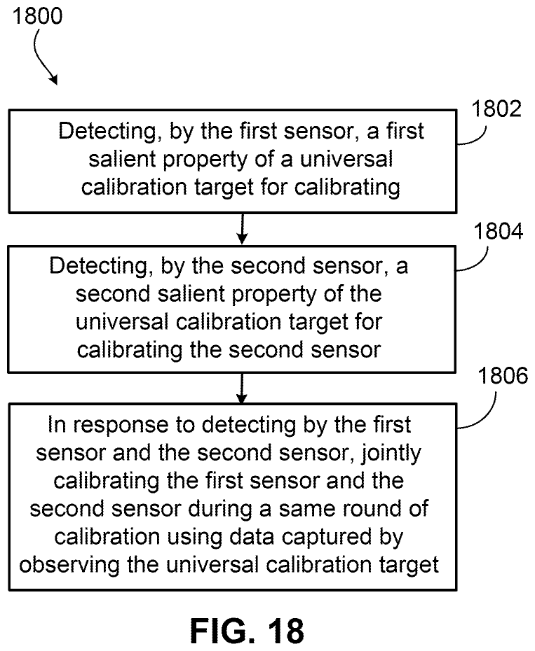

FIG. 18 is a process flow diagram of a process 1800 for universal calibration. At block 1802, a first sensor (e.g., sensors 121 of FIG. 1) detects a first salient property of a universal calibration target (e.g., universal calibration target 900B of FIG. 9B, universal calibration target 1000 of FIG. 10, universal calibration target 1100 of FIG. 11, universal calibration target 1200 of FIG. 12, universal calibration target 1300 of FIG. 13) for calibrating. A universal calibration target fuses a plurality of distinct salient properties that each correspond to one or more sensor modalities into a single calibration target. Accordingly, at block 1804, a second sensor (e.g., sensors 121 of FIG. 1) detects a second salient property of the universal calibration target for calibrating the second sensor. In embodiments, a salient property is intentionally implemented at the universal calibration target for the purpose of being observed by a corresponding sensor. At block 1806, in response to detecting by the first sensor and the second sensor, the first sensor and the second sensor are simultaneously calibrated during a same round of calibration using data captured by observing the universal calibration target.

In an embodiment, a calibration system can access sensor data of the sensors to be calibrated either as part of the on-robot software system, or via an external logging interface (which the robot must provide its sensor observations to). Moreover, calibration algorithms are applied to the sensed data from the room and robot. The calibration algorithms combine the sensor data and apply algorithms to estimate the calibration parameters. In embodiments, these algorithms execute in real-time with direct feedback and control of the room. In an embodiment, the algorithms are processed in an offline manner via logged data playback and the output of the algorithms are the calibration parameters of the robot. Additionally, in an embodiment, calibration procedures using a universal calibration target (e.g., universal calibration target 900B of FIG. 9B, universal calibration target 1000 of FIG. 10, universal calibration target 1100 of FIG. 11, universal calibration target 1200 of FIG. 12, universal calibration target 1300 of FIG. 13), calibration space (e.g., calibration space 1400 of FIG. 14, calibration space 1500 of FIG. 15) or a calibration room (e.g., calibration room 1700 of FIG. 17) according to the present techniques are modified by removing environmental and noise compensation factors. By controlling the calibration room and space, the effect of the environment and space on calibration or verification procedures is minimized. Further, the present techniques can be implemented using various designs, equipment, and operational procedures of a calibration facility. Calibration space software interfaces with the calibration space or calibration room to control the automation capabilities of the calibration space or calibration room. For example, automation capabilities include drivers and controllers for the sensors, actuators, and any electronically controllable elements (e.g. lights) of the calibration space or calibration room.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A universal calibration target, comprising:
a core associated with a first salient property; and
an outer body associated with a second salient property, wherein the first salient property and the second salient property are configured to be observed by a sensor modality, and wherein the first salient property and the second salient property correspond to at least one sensor of a vehicle.

2. The universal calibration target of claim 1, wherein the first salient property and the second salient property are selected based on the corresponding sensor modality.

3. The universal calibration target of claim 1, wherein the first salient property or the second salient property corresponds to a plurality of sensors.

4. The universal calibration target of claim 1, wherein the core comprises a radar reflector.

5. The universal calibration target of claim 1, wherein the outer body comprises a Styrofoam outer body.

6. The universal calibration target of claim 1, wherein the outer body is extensible relative to the core.

7. The universal calibration target of claim 1, wherein the surface of the outer body comprises a pattern or color to calibrate a camera.

8. The universal calibration target of claim 1, wherein the vehicle observes the target and calibrates the at least one sensor, wherein the calibration occurs without environmental or noise factors.

9. A vehicle, comprising:
a first sensor;
a second sensor;
at least one computer; and
a memory storing instructions that when executed by the at least one computer, cause the at least one computer to perform operations comprising:
detecting, by the first sensor, a first salient property of a universal calibration target for calibrating the first sensor;
detecting, by the second sensor, a second salient property of the universal calibration target for calibrating the second sensor; and
in response to detecting by the first sensor and the second sensor, simultaneously calibrating the first sensor and the second sensor during a same round of calibration using data captured by observing the universal calibration target.

10. The vehicle of claim 9, wherein the operations comprise causing the vehicle to travel along a calibration path, wherein the calibration path comprises a plurality of universal calibration targets.

11. The vehicle of claim 9, wherein the operations comprise verifying calibration parameters of the first sensor and calibration parameters of the second sensor.

12. The vehicle of claim 9, wherein the operations are performed in a calibration room.

13. The vehicle of claim 9, wherein a verification occurs in response to erroneous sensor values.

14. The vehicle of claim 9, wherein a first algorithm and a second algorithm are to simultaneously calibrate the first sensor and the second sensor based on, at least in part, the first salient property and the second salient property.

15. A method comprising:
detecting, by the first sensor, a first salient property of a universal calibration target for calibrating the first sensor;
detecting, by the second sensor, a second salient property of the universal calibration target for calibrating the second sensor; and
calibrating, by a control circuit, the first sensor and the second sensor during a same round of calibration using data captured by observing the universal calibration target in response to detecting by the first sensor and the second sensor.

16. The method of claim 15, wherein at first salient property and the second salient property are selected based on a configuration of a corresponding sensor.

17. The method of claim 15, wherein the first salient property or the second salient property corresponds to a plurality of sensors.

18. The method of claim 15, wherein universal calibration target comprises a core and an outer body, wherein a pattern or color is applied to the surface of the outer body.

19. The method of claim 15, wherein the universal calibration target is positioned at a predetermined location with respect to the first sensor and the second sensor.

20. The method of claim 15, wherein the universal calibration target is modified based on calibration requirements of the first sensor or the second sensor.

21. (canceled)
